(19) United States
(12) Patent Application Publication
(10) Pub. No.: US 2007/0182534 A1
(43) Pub. Date: Aug. 9, 2007

(54) Apparatus and method for indicating seatbelt usage

(76) Inventor: Rory Gregory, New Rochelle, NY (US)

Correspondence Address: RUSSELL S. SALERNO, 775 PARK AVENUE, SUITE 255, HUNTINGTON, NY, 11743, US

(21) Appl. No.: 11/348,859

(22) Filed: Feb. 7, 2006

(51) Int. Cl. B60Q 1/00; B60R 22/00

(52) U.S. Cl. 340/457.1; 280/801.1

(57) ABSTRACT

The present invention enables observers to rapidly determine whether a seat belt is properly fastened. When the seat belt buckle is latched a circuit is completed which activates an array of lights incorporated with the seat belt fabric. When illuminated, the lights provide to an observer positive visual confirmation the belt is latched. The disclosed invention promotes safety by permitting law enforcement officers, aircraft cabin attendants, amusement park ride operators and the like to verify at a glance, regardless of ambient lighting conditions, whether seat belts are being used as required.

### BACKGROUND OF THE INVENTION

1. Field of the Invention

The present invention relates to the field of seatbelt and safety harnesses and more particularly to a seatbelt with self-contained indicator lights which communicate the status of the seatbelt latch.

2. Description of the Related Art

The benefits of restraining belts such as seat belts and safety harnesses in vehicles are well recognized. Studies by the automotive, aerospace, and insurance industries have shown that proper use of a seat belt or safety harness significantly reduces the risk of injury to the wearer in the event of a collision. However, such benefits do not accrue unless the devices are properly worn by the user.

Public policy has also recognized the substantial injury-reducing benefits of seat belt usage. Accordingly, municipal laws and insurance regulations have been enacted which require the use of seat belts and safety harnesses by occupants of motor vehicles, passenger aircraft, and other forms of motorized transport including without limitation warehouse “hi-lo” machines, heavy construction equipment, and amusement park rides.

The task of enforcing rules mandating seatbelt use by has fallen, in the case of motor vehicles, upon the police and constabulary; in passenger aircraft, upon flight attendants; in industrial equipment, upon supervisors and safety officers; and in the case of amusement park rides, upon ride operators. Customarily, the means to assess whether a seat belt is being properly used is by visually acquiring the subject person and belt apparatus together in a situational context and making a cognitive determination as to whether the belt is in fact being worn properly, a fatiguing and error-prone process. Additionally, unaided visual assessment is ineffective beyond moderate distances. Sometimes, in the event of a pending traffic stop, a subject will feign proper belt usage by pulling an unworn shoulder harness across his or her body without actually latching the buckle, making difficult a positive determination as to whether the belt was properly worn. It is therefore desirable to assist in the observation of subject persons by providing a supplementary indication of seat belt usage by the occupants of a vehicle.

One system devised for detecting usage of vehicle restraints is disclosed in U.S. Pat. No. 4,849,733 issued to Conigliaro et al. Conigliaro discloses a means for providing rearward-facing lights on the exterior of a vehicle which illuminate to indicate that an occupant has not fastened their seat belt.

U.S. Pat. No. 6,774,781 issued to Lee discloses a safety light comprising a brake light, and a seat belt light which extinguishes when a seat belt is buckled.

U.S. Pat. No 6,059,066 issued to Lary discloses a seat belt usage indicator which employs fender-mounted lights adapted to emit light of varying colors dependant upon the state of seat belt usage within the vehicle.

U.S. Pat. Appl. Pub. No. 2005/0156726 of Rubel discloses a seat belt usage monitoring system for recording seat belt usage information locally within the vehicle, and for transmitting the information to a remote monitoring receiver.

What is lacking in the prior art is a means to incorporate a seat belt usage monitoring system into the vehicle without necessitating costly or extensive engineering changes, for example, without adding undue complexity or weight to the wiring harness, without the use of costly data transmitters and antennae, or without requiring the mechanical and aesthetic integration of additional warning lights into the styling of the vehicle. A corollary disadvantage is the inherent difficulty and expense of retrofitting the prior art systems into an existing vehicle, which would be desirable in, for example, fleet vehicles such as rental cars, taxicabs, or tractor trailers. Another disadvantage of the prior art teachings is a lack of an easily-grasped and intuitive correlation between indicator state and seat belt usage. Still another disadvantage to certain prior art inventions is that numerous costly remote receivers are needed to receive and process radio signals containing encoded seat belt usage data. Yet another disadvantage of prior art systems is that they are poorly suited for use in non-automotive applications.

### SUMMARY OF THE INVENTION

It is therefore an object of the present invention to provide a seat belt usage indicator which is readily incorporable into the design of new production vehicles at minimal cost and effort.

It is another object of the present invention to provide a seat belt usage indicator which is easily retrofitted into already-manufactured vehicles.

It is still another object of the present invention to provide a seat belt usage indicator which will visually convey the usage status of a seat belt or safety harness to an observer with rapidity, accuracy and without undue fatiguing effects.

Yet another object of the present invention is to provide a seat belt usage indicator which is well-suited for use in all applications incorporating a seat belt or safety harness, such as such as passenger aircraft, industrial equipment, and amusement park rides.

In accordance with the present invention, there is disclosed a seat belt usage indicator apparatus and method comprising a seat belt or safety harness; an array of lights incorporated with the seat belt webbing material; associated conductors incorporated into the webbing material to provide electrical power or optical signals to said lights; and means for illuminating said lights when the seat belt buckle is latched. When the seat belt is not in use, i.e., when the corresponding seat is vacant or when the corresponding seat is occupied but the belt is unlatched, the lights on the belt will be unlit. Contrastingly, when the belt is in use, i.e., when the corresponding seat is occupied and the belt is latched, the lights on the belt will illuminate. Thus an observer is readily able to discern whether each seat in a vehicle is occupied, and, if so, whether the seat belt is latched.

### BRIEF DESCRIPTION OF THE DRAWINGS

FIG. 1 is a perspective view of the preferred embodiment of the present invention comprising the buckles and electrical contacts, seat belt webbing, conductors and lights.

FIG. 2 is a cross sectional view of one aspect of an embodiment of the invention.

FIG. 3 is an electrical schematic diagram of an embodiment of the present invention.

FIG. 4 is a perspective view of the invention showing its operation and relationship to a vehicle occupant.

FIG. 5 is a perspective view of a vehicle equipped with an embodiment of the present invention.

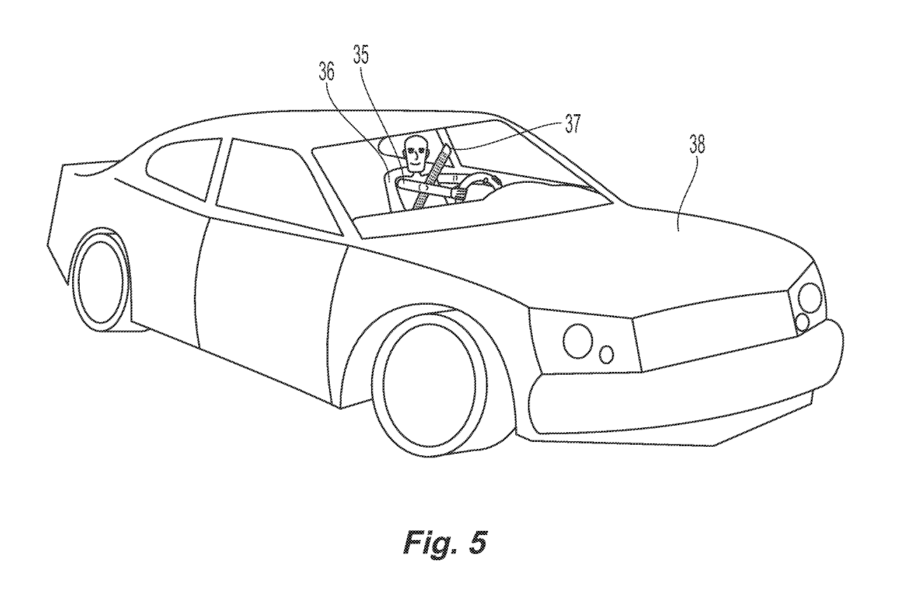

### DETAILED DESCRIPTION OF THE INVENTION

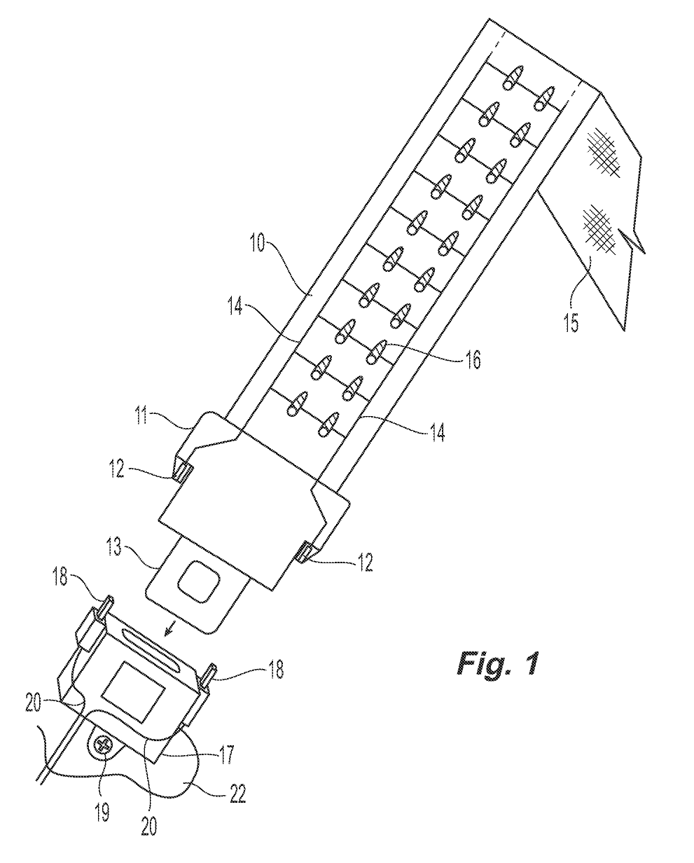

With reference to FIG. 1, restraining belt webbing 10 comprises a network of flexible embedded conductors 14 which are woven into, laminated, bonded or affixed to the load-bearing webbing material. Webbing 10 terminates in a latch assembly 11 which comprises connectors 12 and latch plate 13. Conductors 14 originate at connectors 12 to provide power to light sources 16. Light sources 16 are disposed across the face of webbing 10, preferably in a repeated pattern such as regularly-spaced rows and columns. Buckle 17 having mating connectors 18 is anchored to the vehicle 22 by a suitable mounting means 19 which will be familiar to the skilled artisan. In the preferred embodiment, connectors 18 and conductors 20 are of an electrically-conductive material, such as copper, and light sources 16 are a miniature light-emitting diode (LED) type. Conductors 20 provide electrical power, which, in the preferred embodiment is supplied from the vehicle's wiring harness, to mating connectors 18. In an embodiment, the back surface of webbing 10 is coated with optically reflective material 15. In one embodiment connectors 12 and 18 are coupled inductively.

In one embodiment, the conductors 14 are comprised of a flexible fiber optic material, lights 16 are the light-emitting terminus of said fiber optic conductors, and connectors 12 and 18 are of a fiber optic type, which is well-known in the art. In one embodiment, at least one of buckle 17, connector 12, and connector 18, comprises a light source which provides illumination into the fiber optic conductors 14.

Power is applied to conductors 20 at all times an indication of restraining belt usage is desirable. For example, when embodied in a motor vehicle 38, power is applied to conductors 20 while the vehicle is in operation, typically, when the ignition switch is in the “ON” or “RUN” position. In another embodiment, for instance, in a warehouse “hi-lo” machine, power is applied whenever the machine is operating, or alternatively, whenever the lifting platform is elevated. In yet another embodiment, for example, in an amusement park ride, power is applied at all times the ride is in operation, or alternatively, at times when riders are present on the ride and are required to wear the restraining belt.

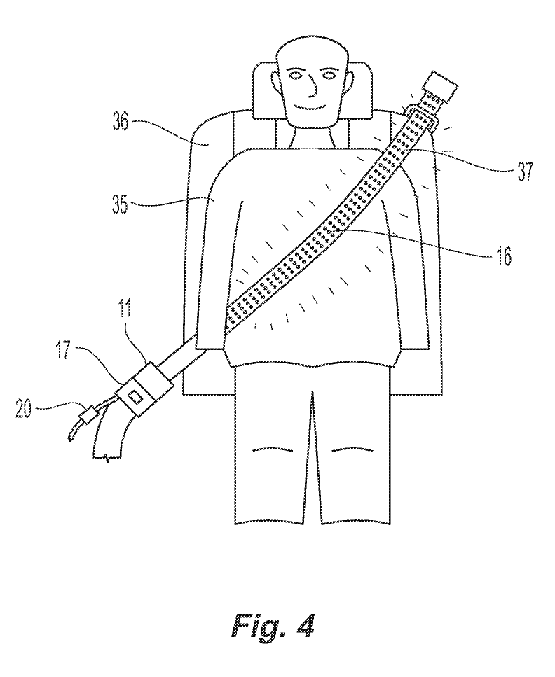

When the invention is not being worn by a user 35 (i.e., the seat 36 or position at which the invention is installed is unoccupied) or the seat or position is occupied by a user and the restraining belt (seat belt) is unbuckled, contacts 18 and 12 are disengaged rendering lights 16 inoperative. Thus, the invention will readily indicate to an observer when a seat or position is occupied by an individual whose seat belt is unlatched, because the observer will see the individual, but not a lighted seat belt. Conversely, as illustrated in FIG. 4., when the seat is occupied and the belt is latched, the invention will so indicate this fact to the observer in that the observer will see an individual with a corresponding lighted belt 37. Finally, when the seat is unoccupied, the observer simply disregards the seat belt lights.

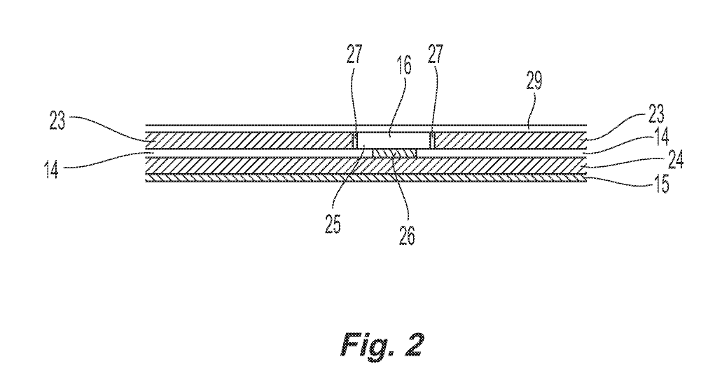

The preferred embodiment is further described with reference to FIG. 2. Conductors 14 are laminated between top webbing layer 23 and bottom webbing layer 24. LED light source 16 is electrically connected to conductors 14 via electrically-conductive bond 25. In the preferred embodiment, bond 25 is effectuated by soldering. LED light source 16 is physically affixed to webbing by physical bonding means 26 and 27. In the preferred embodiment, physical bonding means is by adhesive. Ideally, the top surface of light source 16 is flush with the top surface of top webbing layer 23. In an embodiment, the invention may comprise an optically-permeable protective layer 29.

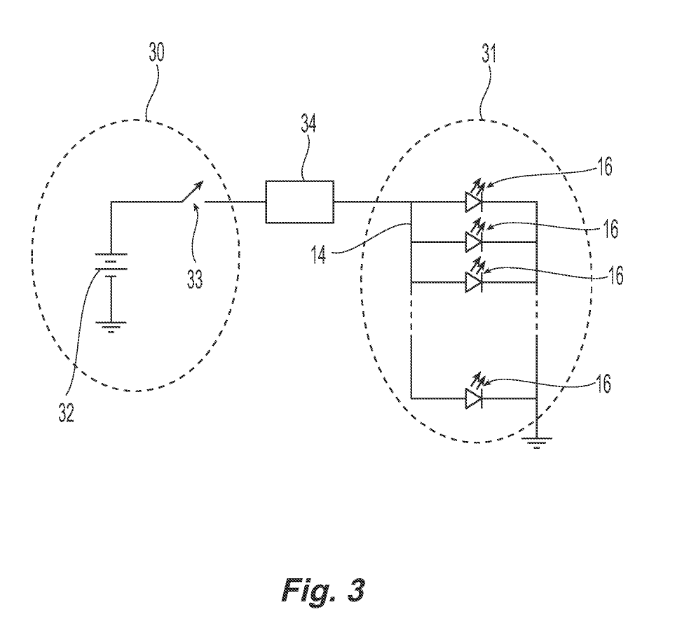

The electrical aspects of an embodiment of the invention are illustrated in FIG. 3. Vehicle wiring harness 30 (comprising power source 32 and switch 33) is connected by a controller 34 to conductors 14 and LED light sources 16. Switch 33 is closed whenever it is intended that an occupant be wearing his or her corresponding safety belt. For example, when the invention is embodied in a motor vehicle, switch 33 will be closed whenever the vehicle is capable of motion, i.e., when the ignition is in the “RUN” position. The controller comprises a current-limiting circuit such as a single resistor, a pulse-width modulation circuit, or other means which will be familiar to the skilled artisan.

In an embodiment, the light sources 16 are of a multi-color type whose instant color is determined by the controller 34. Light sources 16 may also be individually addressed by the controller 34 through techniques familiar to the skilled practitioner, such as multiplexing, thus permitting the display of textual, graphic or animated images on the seat belt.

In an embodiment, controller 34 comprises a means to measure ambient lighting conditions, such as a photocell, and to adjust the intensity of light sources 16 in accordance thereto.

It will be appreciated by the skilled artisan that the invention may easily be retrofitted into existing vehicles, requiring the mere replacement of the existing seat belt webbing, latch and buckle, and a single electrical connection to the vehicle's wiring harness.

It is to be understood that while several embodiments of the present invention have been described in detail for purposes of illustration, various modifications and other configurations which include more, less, or only a single element, may be made without departing from the spirit and scope of the invention.

What is claimed is:

1. Apparatus comprising:
a restraining belt;
at least one conductive element disposed within said restraining belt;
at least one light source in communication with said conductive element;
a latch affixed to said restraining belt having at least one first connector in communication with said conductive element, said latch having a corresponding mating buckle having at least one second connector corresponding to said first connector;
whereby said light source is illuminated when said latch is mated to said buckle.

2. The apparatus of claim 1, wherein said light source is a light-emitting diode and said conductive element comprises electrically conductive material.

3. The apparatus of claim 1, wherein said light source is the terminus of an optical fiber and said conductive element comprises fiber optic material.

4. The apparatus of claim 1, wherein a surface of said restraining belt is of an optically reflective material.

5. The apparatus of claim 1, wherein the outer layer of said restraining belt is of a light-permeable material.

6. A method of indicating restraining belt usage comprising the steps of:
detecting whether the restraining belt is latched;
when latched, causing light sources disposed upon the restraining belt to emit light.

7. A system for indicating proper restraining belt usage, the system comprising:
means for restraining a passenger in a vehicle; and
means for indicating the whether the means for restraining is properly connected comprising:
at least one conductive element in a fastener coupled to the means for restraining; and
at least one indicator.

8. The system of claim 7, wherein said at least one indicator is a light.

9. The system of claim 7, wherein said means for restraining is a seat belt.

10. The system of claim 7, wherein said means for restraining is a seat belt.

11. The system of claim 7, wherein said at least one conductive element conducts electricity.

12. The system of claim 7, wherein said at least one conductive element conducts light.

13. The system of claim 7, wherein said fastener is a buckle.
